(19) United States
(12) Patent Application Publication
(10) Pub. No.: US 2008/0282643 A1
(43) Pub. Date: Nov. 20, 2008

(54) Self-Adjusting and/or Self-Locking Concrete or Cinder Block Lifting Device

(76) Inventor: Patrick Edward Devens, Blacksburg, VA (US)

Correspondence Address: PATRICK EDWARD DEVENS, 1795 ST. ANDREWS CIRCLE, BLACKSBURG, VA, 24060, US

(21) Appl. No.: 11/676,581

(22) Filed: Feb. 20, 2007

(51) Int. Cl. E04G 21/16; B65G 7/12

(52) U.S. Cl. 52/749.13; 294/62

(57) ABSTRACT

A self-adjusting and/or self-locking concrete or cinder block and/or other object lifting device having a stationary assembly 13 including a stationary handle portion 15, a stationary horizontal middle bar portion 16, two stationary leg portions 17 and 18, a stationary jaw portion 19, and a stationary connection portion 20 and a moveable assembly 21 including an operating lever 3, a moveable jaw portion 22, and two teeth portions 24 and 25 that is supported on the stationary assembly 13 with a first pivot pin 1ST about which the stationary assembly 13 and the moveable assembly 21 pivot permitting the moveable jaw portion 22 to automatically close down on and/or grip a concrete or cinder block web disposed between the stationary jaw portion 19 and moveable jaw portion 22 by providing gravity based self-adjustment for different sized objects to be gripped and/or pinched between the jaws when the stationary handle portion 15 is pulled upward. The operating lever 3 that is kept aligned by the stationary assembly 13 and supported on the moveable jaw portion 22 with a second pivot pin 2ND about which the operating lever 3 and the moveable jaw portion 22 pivot permitting the gravity based operating lever 3 to move freely until an object is gripped between the stationary jaw portion 19 and moveable jaw portion 22 and the stationary handle 15 is lifted and/or raised to lift and/or raise the concrete or cinder block. When the stationary jaw portion 19 and moveable jaw portion 22 grip the concrete or cinder block, the operating lever 3 is prevented by the concrete or cinder block weight from releasing the concrete or cinder block until the concrete or cinder block places no gravitational, downward, and/or pinching force on the jaws and the operating lever 3 is lifted and/or raised to release the moveable jaw portion 22 from gripping the concrete or cinder block. The specific design and/or arrangement of the moveable jaw portion 22 to which is connected with the second pivot pin 2ND to the moveable operating lever 3 in further combination with the fact that the stationary handle portion 15 that is connected to the stationary jaw portion 19 to which it is connected with the first pivot pin 1ST to the moveable jaw portion 22 provides a self-adjusting and/or self-locking concrete or cinder block and/or other object lifting device.

### FIELD OF THE INVENTION

The present invention relates generally to utility lifting devices and, more particularly to lifting devices that self-adjust for grasping an object and/or self-locking lifting devices for automatically locking the device's jaws into engagement with an object.

### DESCRIPTION OF THE PRIOR ART

Many types of handheld utility lifting devices are known in the art. Conventional lifting devices typically include two or more members interconnected in a scissor-like and/or lever-like arrangement allowing for an object to be grasped by jaw portions of the devices in response to movement of handle portions of the devices. Over the years, numerous improvements have been made to conventional lifting device designs in order to obtain better and more efficient lifting devices. For example, self-adjusting lifting devices have been developed in order to provide a set of lifting devices that more easily adjust to the size of a given object. In addition, self-locking lifting devices have been developed in order to provide a set of jaws that will allow the jaws to remain in locking engagement with the object.

Self-adjusting or automatic-adjusting lifting devices for concrete cinder block include tailored variations of the conventional lifting devices. Examples of scissors-like self-adjusting lifting devices are disclosed in U.S. Pat. Nos. 6,254,157 (2001) and 5,490,702 (1996). These designs are hampered by their complexity and size limitations. Examples of less complicated designs are disclosed in U.S. Pat. Nos. 5,820,180 (1998) and 3,237,979 (1966). The disadvantage of these devices is that they are not self-locking. The least complex devices are disclosed in U.S. Pat. Nos. 4,982,987 (1991) and 4,463,979 (1984). These designs have minimal moving parts and use gravity for self-locking. Their limitation is production cost and the ability to accommodate varying concrete or cinder block shapes.

There remains a need for an economical self-adjusting and/or self-locking concrete or cinder block lifting device which provides a user the means of easily grasping and lifting any standard size concrete or cinder block using one hand. It is a principal object of the present invention to provide such a self-adjusting and/or self-locking concrete or cinder block lifting device which is easy to operate, fully functional, and inexpensive to manufacture.

### SUMMARY OF THE INVENTION

The present invention has met the above described needs by providing for a self-adjusting and/or self-locking concrete or cinder block and/or other object lifting device.

The self-adjusting and/or self-locking concrete or cinder block lifting device for grasping and lifting a concrete or cinder block and/or other object includes:

A self-adjusting and/or self-locking concrete or cinder block and/or other object lifting device having a stationary assembly 13 including an intermediate portion 14, a stationary handle portion 15, a stationary horizontal middle bar portion 16, two stationary leg portions 17 and 18, a stationary jaw portion 19, and a stationary connection portion 20 and a moveable assembly 21 including an operating lever 3, a moveable jaw portion 22, and two teeth portions 24 and 25 that is supported on the stationary assembly 13 with a first pivot pin 1ST about which the stationary assembly 13 and the moveable assembly 21 pivot permitting the moveable jaw portion 22 to automatically close down on and/or grip a concrete or cinder block web disposed between the stationary jaw portion 19 and moveable jaw portion 22 by providing gravity based self-adjustment for different sized objects to be gripped and/or pinched between the jaws when the stationary handle portion 15 is pulled upward. The operating lever 3 that is kept aligned by the stationary assembly 13 and supported on the moveable jaw portion 22 with a second pivot pin 2ND about which the operating lever 3 and the moveable jaw portion 22 pivot permitting the gravity based operating lever 3 to move freely until an object is gripped between the stationary jaw portion 19 and moveable jaw portion 22 and the stationary handle 15 is lifted and/or raised to lift and/or raise the concrete or cinder block. When the stationary jaw portion 19 and moveable jaw portion 22 grip the concrete or cinder block, the operating lever 3 is prevented by the concrete or cinder block weight from releasing the concrete or cinder block until the concrete or cinder block places no gravitational, downward, and/or pinching force on the jaws and the operating lever 3 is lifted and/or raised to release the moveable jaw portion 22 from gripping the concrete or cinder block. The specific design and/or arrangement of the moveable jaw portion 22 to which is connected with the second pivot pin 2ND to the moveable operating lever 3 in further combination with the fact that the stationary handle portion 15 that is connected to the stationary jaw portion 19 to which it is connected with the first pivot pin 1ST to the moveable jaw portion 22 provides a self-adjusting and/or self-locking concrete or cinder block and/or other object lifting device.

In a preferred embodiment, the self-adjusting and/or self-locking concrete or cinder block lifting device is always employed in an upright position so that the stationary assembly 13 handle portion 15 is up and the stationary jaw portion 19 and moveable jaw portion 22 are down while the concrete or cinder block to be lifted is positioned as it would be placed or so that the interior webs are vertically aligned, large internal block cavities are viewable by looking down. The stationary assembly 13 is inserted over a concrete or cinder block center-most web and fully depressed downward so that the concrete or cinder block web is positioned opposite the stationary handle portion 15 between the two stationary leg portions 17 and 18 with the stationary jaw portion 19 teeth being in contact with one side of the concrete or cinder block web and the top of the concrete or cinder block web touching the stationary horizontal middle bar portion 16. As the concrete or cinder block web is being inserted between the stationary leg portions 17 and 18, the moveable jaw portion 22 will be displaced by the concrete or cinder block web and will rotate on the first pivot pin 1ST toward the stationary horizontal middle bar portion 16. This action will result in the moveable assembly 21 teeth portions 24 or 25 being in contact with the opposite side of the concrete or cinder block web, directly in line with and/or directly opposite the stationary jaw portion 19 teeth. As the moveable jaw portion 22 rotates, the operating lever 3 will simultaneously rotate toward the stationary handle portion 15 on the second pivot pin 2ND and be guided by an opening in the stationary horizontal middle bar portion 16. This procedure will result in the concrete or cinder block web being fully inserted between the stationary leg portions 17 and 18 with the concrete or cinder block web top touching the stationary horizontal middle bar portion 16 and both the stationary jaw portion 19 teeth and moveable assembly 21 teeth portion 24 or 25 touching directly opposite sides of the concrete or cinder block web. Pulling up on the stationary handle portion 15 will cause the moveable jaw portion 22 to rotate downward or away from the stationary horizontal middle bar portion 16 on the first pivot pin 1ST as the stationary jaw portion 19 teeth and moveable assembly 21 teeth portion 24 or 25 grip the concrete or cinder block web and the concrete or cinder block weight pulls the moveable jaw portion 22 downward, due to gravity. The moveable jaw portion 22 downward rotation and design shape will result in the concrete or cinder block web being gripped and/or pinched between the stationary jaw portion 19 teeth and moveable assembly 21 teeth portion 24 or 25, creating a self-adjusting and/or self-locking concrete or cinder block lifting device. As long as the stationary handle portion 15 is pulled upward, the concrete or cinder block center-most web will be gripped, and the concrete or cinder block may be lifted and/or transported. Once the concrete or cinder block is placed on a surface and/or no weight is placed on the moveable jaw portion 22, the operating lever 3 may be pulled upward or toward the stationary horizontal middle bar portion 16. This action will rotate the moveable jaw portion 22 toward the stationary horizontal middle bar portion 16 by use of and rotation about the second 2ND and first 1ST pivot pins. Once the moveable jaw portion 22 is no longer in contact with the concrete or cinder block web, the self-adjusting and/or self-locking concrete or cinder block lifting device may be removed, released, and/or disengaged from the block.

In a further embodiment, the moveable jaw portion 22 is designed to accommodate varying concrete or cinder block web thicknesses. The moveable assembly 21 teeth portion 24 nearest to the stationary jaw or furthest from the first pivot pin 1ST are used to grip narrow concrete or cinder block webs. The moveable assembly 21 teeth portion 25 nearest the first pivot pin 1ST are used to grip thick concrete or cinder block webs. This allows the self-adjusting and/or self-locking concrete or cinder block lifting device to be used for a large variety of concrete or cinder block shapes and/or configurations.

In another embodiment, the self-adjusting and/or self-locking concrete or cinder block lifting device is easy to use. The device is operated by one hand, right or left. The stationary handle portion 15 is ergonomically designed to optimally and most effectively accommodate a person's hand while the operating lever is positioned to allow ease of operation by the same hand. A person can also use two self-adjusting and/or self-locking concrete or cinder block lifting devices to carry two concrete or cinder blocks at one time, one device in each hand. The only limitation is whether the person can physically carry the weight associated with two concrete or cinder blocks. If the person is capable of carrying two concrete or cinder blocks, using two self-adjusting and/or self-locking concrete or cinder block lifting devices offers an additional benefit of balancing the load across the person's whole body.

In yet another embodiment, the self-adjusting and/or self-locking concrete or cinder block lifting device is durable and easy to manufacture. The device is manufactured by riveting together stamped metal parts, polymer filler inserts, and the handle. The number of components and simplicity of design complexity, and repetitive shape of parts yield a device which can be efficiently manufactured. The device's only wearable parts are the stationary assembly 13 members 4 and moveable assembly 21 members 7 which are replaceable parts secured by removable fasteners. The stationary assembly 13 members 4 and moveable assembly 21 members 7 can also be manufactured from a variety of materials designed to grasp the concrete or cinder block and/or other object better. These built-in design features make the device easy to manufacture and durable, resulting in an efficient and cost effective tool.

It is, therefore, an object of the present invention to provide a self-adjusting and/or self-locking concrete or cinder block lifting device for automatically locking stationary jaw portion 19 and moveable jaw portion 22 of the device into engagement with a concrete or cinder block and/or other object.

It is also an object of the present invention to provide a self-adjusting and/or self-locking concrete or cinder block lifting device capable of grasping concrete or cinder block webs of different thicknesses.

It is a further object of the present invention to provide a self-adjusting and/or self-locking concrete or cinder block lifting device which has few moving parts and uses the concrete or cinder block weight and/or gravity as the primary element to provide an enhanced grasping capability.

It is another further object of the present invention to provide a self-adjusting and/or self-locking concrete or cinder block lifting device that can be easily and efficiently operated by one hand and can be operated by either hand and/or allow the operator to use a device in each hand to lift two concrete or cinder blocks simultaneously.

It is an object of the present invention to provide a self-adjusting and/or self-locking concrete or cinder block lifting device such that an unskilled person may operate the self-adjusting and/or self-locking concrete or cinder block lifting device.

It is yet another object of the present invention to provide a self-adjusting and/or self-locking concrete or cinder block lifting device that can be easily and efficiently manufactured by stamping, layering and/or sandwiching, and riveting processes.

It is yet another object of the present invention to provide a self-adjusting and/or self-locking concrete or cinder block lifting device that is durable and allows the operator to easily replace worn parts and/or to easily replace grasping parts with a more appropriate grasping material.

It is also an object of the present invention to provide a self-adjusting and/or self-locking concrete or cinder block lifting device having both the capability for grasping the concrete or cinder block and for automatically locking the jaw portions into engagement with the concrete or cinder block and/or other object.

It is another object to provide locking a self-adjusting and/or self-locking concrete or cinder block lifting device that are readily releasable from a locked position and easily reset for further operation.

These and other objects of the invention will be more fully understood from the following description of the invention with reference to the drawings appended hereto.

### BRIEF DESCRIPTION OF THE DRAWINGS

FIG. 1 is a perspective view of a preferred embodiment of the self-adjusting and/or self-locking concrete or cinder block lifting device of the present invention.

FIG. 2 is a front view of the self-adjusting and/or self-locking concrete or cinder block lifting device shown in FIG. 1.

FIG. 3 is a right side view of the self-adjusting and/or self-locking concrete or cinder block lifting device shown in FIG. 1.

FIG. 4 is a top view of the self-adjusting and/or self-locking concrete or cinder block lifting device shown in FIG. 1.

FIG. 5 is a front view of the self-adjusting and/or self-locking concrete or cinder block lifting device shown in FIG. 1.

FIG. 6 is a left side view of the self-adjusting and/or self-locking concrete or cinder block lifting device shown in FIG. 1.

FIG. 7 is a bottom view of the self-adjusting and/or self-locking concrete or cinder block lifting device shown in FIG. 1.

FIG. 8 is a further front view of the self-adjusting and/or self-locking concrete or cinder block lifting device shown in FIG. 1 in a default and/or non-grasping position.

FIG. 9 is a further front view of the self-adjusting and/or self-locking concrete or cinder block lifting device shown in FIG. 1 with the cinder block lifting device being placed on the web of a concrete or cinder block with a ¾ to 2½ inch center web.

FIG. 10 is a perspective view of a preferred embodiment of the self-adjusting and/or self-locking concrete or cinder block lifting device shown in FIG. 1 with the cinder block lifting device being placed on the web of a concrete or cinder block with a ¾ to 2½ inch center web shown in FIG. 9.

FIG. 11 is a further front view of the self-adjusting and/or self-locking concrete or cinder block lifting device shown in FIG. 1 with the cinder block lifting device fully closed and/or positioned on a concrete or cinder block with a ¾ to 2½ inch center web.

FIG. 12 is a perspective view of a preferred embodiment of the self-adjusting and/or self-locking concrete or cinder block lifting device shown in FIG. 1 with the cinder block lifting device fully closed and/or positioned on a concrete or cinder block with a ¾ to 2½ inch center web, shown in FIG. 11.

FIG. 13 is a further front view of the self-adjusting and/or self-locking concrete or cinder block lifting device shown in FIG. 1 with the cinder block lifting device fully closed and/or positioned on a concrete or cinder block with a 2½ to 3 inch center web.

FIG. 14 is a perspective view of a preferred embodiment of the self-adjusting and/or self-locking concrete or cinder block lifting device shown in FIG. 1 with the cinder block lifting device fully closed and/or positioned on a concrete or cinder block with a 2½ to 3 center web, shown in FIG. 13.

FIG. 15 is a further front view of the self-adjusting and/or self-locking concrete or cinder block lifting device shown in FIG. 1 with the cinder block lifting device showing the self-adjusting and/or self-locking concrete or cinder block lifting device with a ¾ to 2½ inch center web with the moveable assembly 21 in a fully open and/or retracted and/or release position.

FIG. 16 is a perspective view of a preferred embodiment of the self-adjusting and/or self-locking concrete or cinder block lifting device shown in FIG. 1 with the cinder block lifting device fully positioned on a concrete or cinder block with a ¾ to 2½ inch center web, stretcher type block, with the moveable assembly 21 in a fully open and/or retracted and/or release position shown in FIG. 15.

FIG. 17 is an exploded perspective view of the stationary assembly 13 of the self-adjusting and/or self-locking concrete or cinder block lifting device shown in FIG. 11.

FIG. 18 is an exploded perspective view of the moveable assembly 21 of the self-adjusting and/or self-locking concrete or cinder block lifting device shown in FIG. 11.

FIG. 19 is an exploded perspective view of a preferred embodiment of the self-adjusting and/or self-locking concrete or cinder block lifting device of the present invention with the device parts list.

### DESCRIPTION OF THE PREFERRED EMBODIMENT

As used herein, the phrase “generally triangular” includes a shape of a triangle, or having the general shape of a triangle, or that functions as the equivalent in the context of the present invention by providing at least two different gripping locations each relating to a function of the operation of the self-adjusting and/or self-locking concrete or cinder block lifting device.

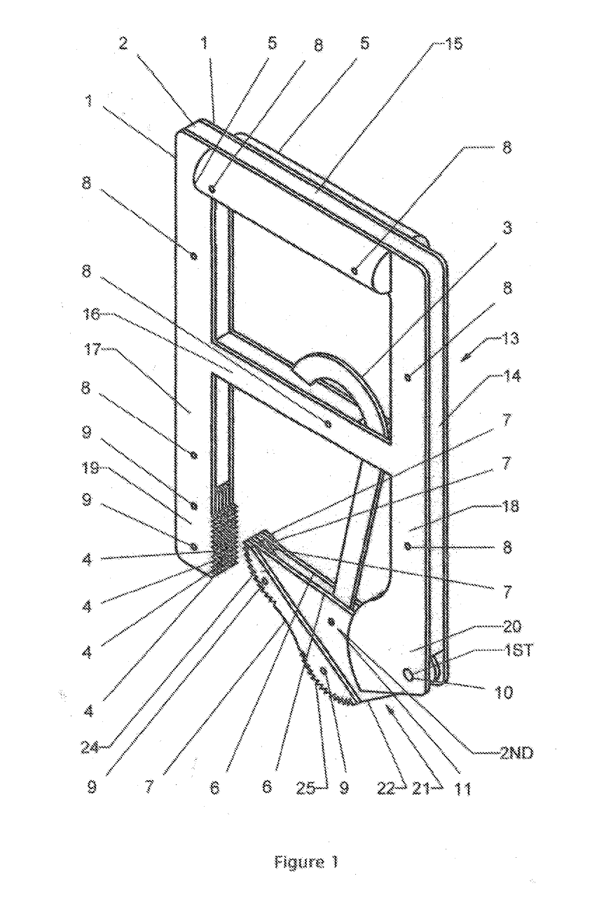

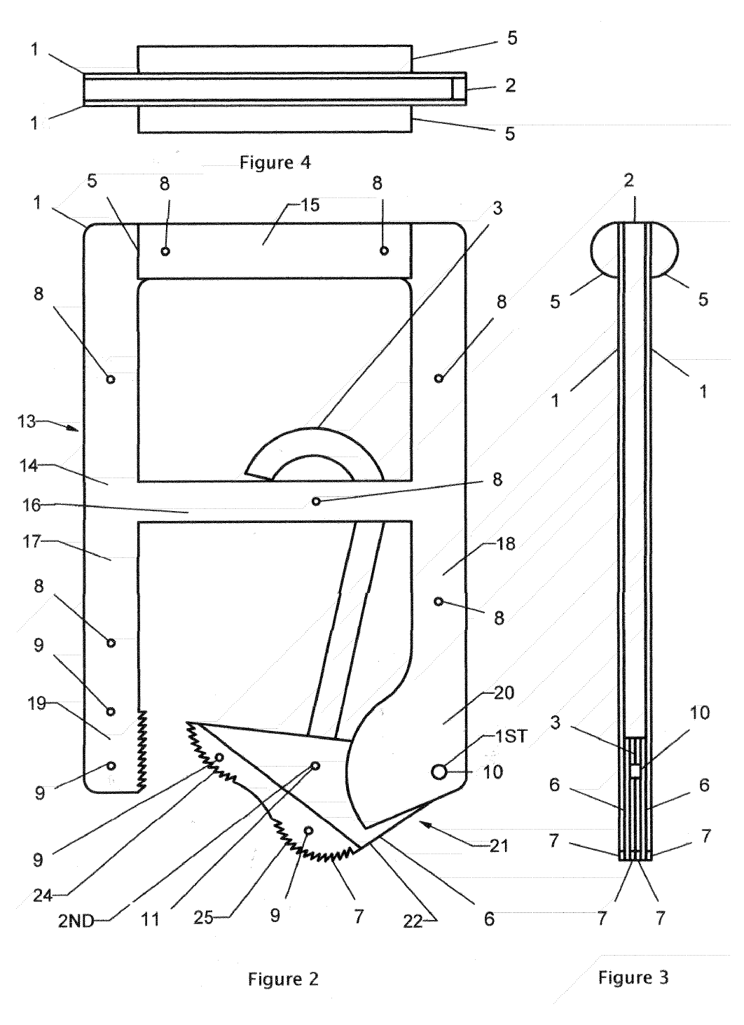

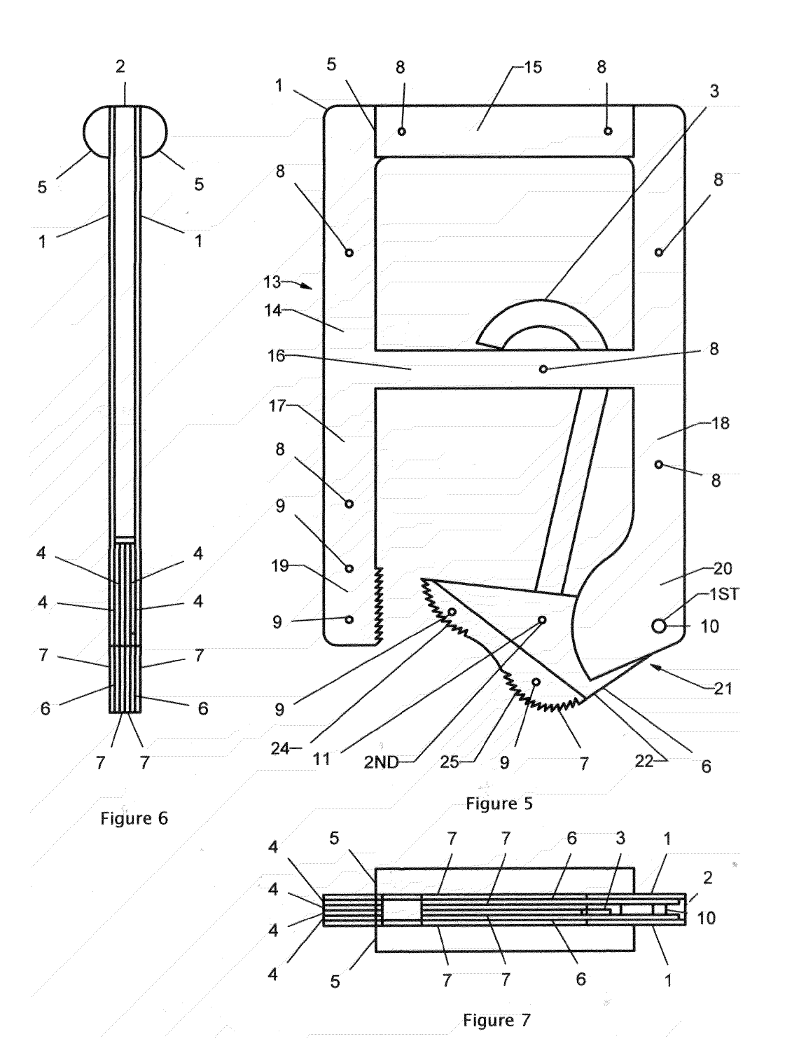

Referring to FIGS. 1-7, there is shown a preferred embodiment of the self-adjusting and/or self-locking concrete or cinder block lifting device stationary assembly 13 and moveable assembly 21 of the present invention. The stationary assembly 13 is interconnected in a scissor-like arrangement with the moveable assembly 21 in order to easily and efficiently adjust to the size of a given concrete or cinder block web. The stationary assembly 13 includes an stationary intermediate portion 14, a stationary handle portion 15, a stationary horizontal middle bar portion 16, two stationary leg portions 17 and 18, a stationary jaw portion 19, and a stationary connection portion 20 at the first pivot pin 1ST. Similarly, the moveable assembly 21 includes an operating lever 3, a moveable jaw portion 22, and two teeth portions 24 and 25, and connection locations at first 1ST and second 2ND pivot pins.

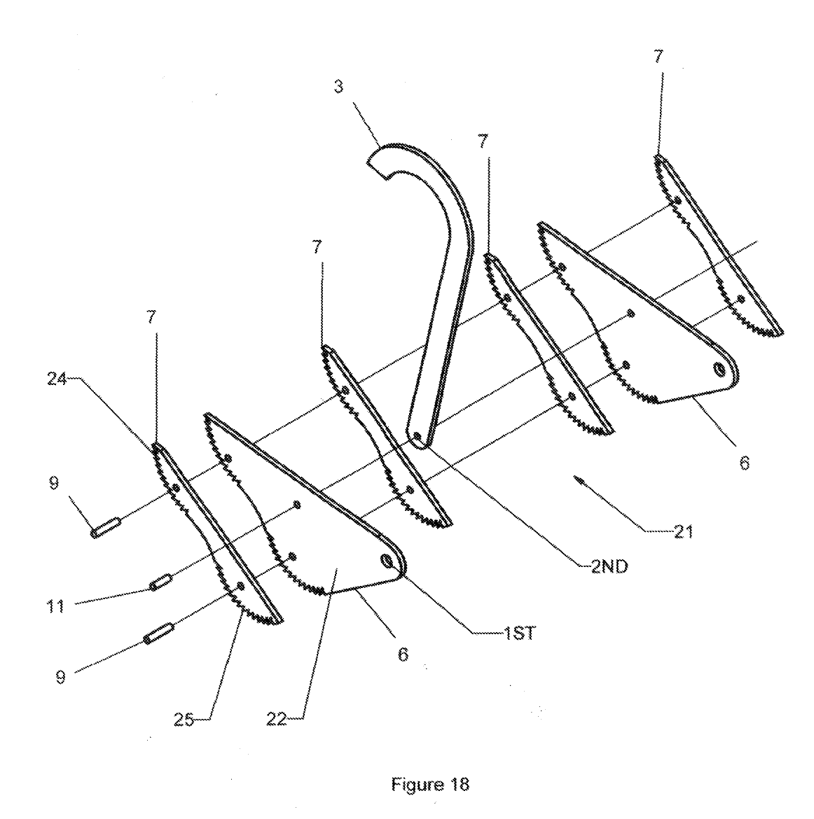

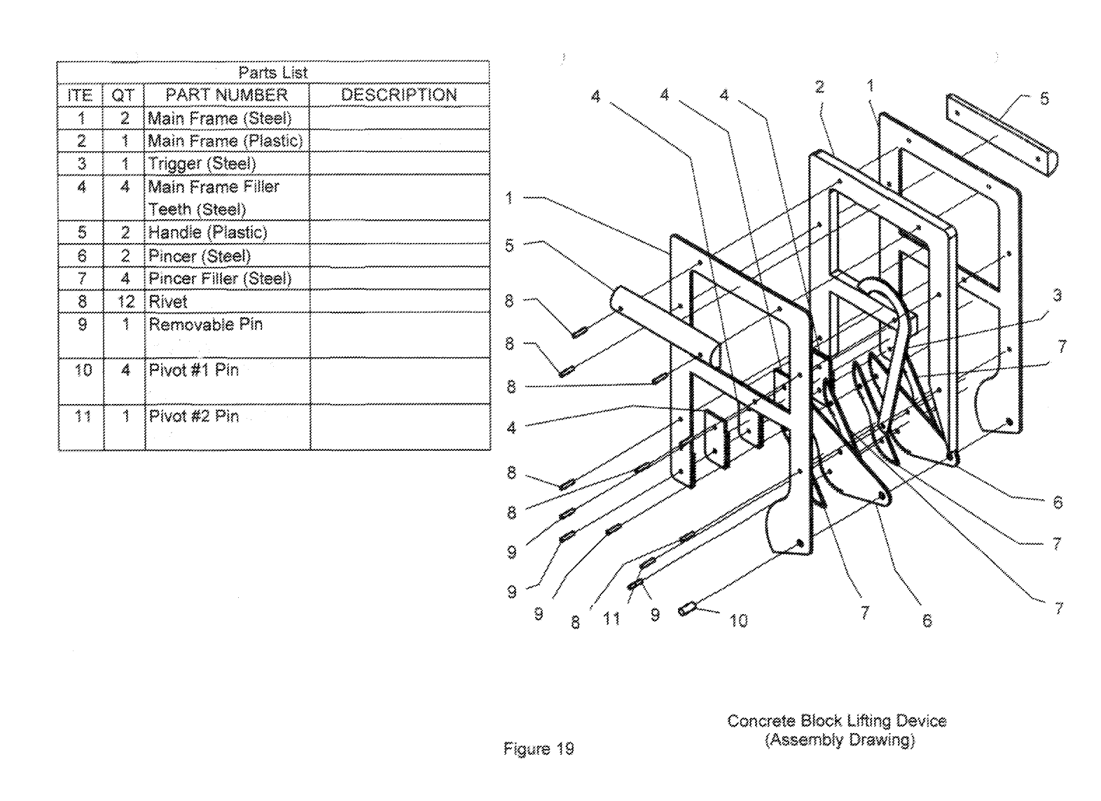

Referring specifically to FIGS. 1-2, 5, 8, and 17-19, the stationary assembly 13 and moveable assembly 21 are preferably formed of laminated construction. As best shown in FIG. 17, the stationary assembly 13 includes outer laminations of member 1 which form the stationary intermediate portion 14, stationary handle portion 15, stationary horizontal middle bar portion 16, two stationary leg portions 17 and 18, stationary jaw portion 19, and the stationary connection portion 20. Inner lamination member 2, of other suitable filler material, is provided between the outer lamination members 1 to complete the intermediate portion 14, stationary horizontal middle bar portion 16, and two stationary leg portions 17 and 18 and to complete the handle portion 15 when the ergonomically designed polymer grip members 5 are added to both sides of the outer lamination members 1. Four inner lamination members 4 are provided between the outer lamination members 1 to complete the stationary jaw portion 19. As best shown in FIG. 18, the moveable assembly 21 includes the moveable jaw portion 22, operating lever 3, and two teeth portions 24 and 25. Two inner laminations of tooth member 7, sandwiched between moveable member 6 laminations, and outer laminations of tooth member 7 complete the formation of the moveable assembly 21. The inner laminations of two tooth members 7 allows for relative movement of operating lever 3 between the moveable member 6 laminations. In addition, stationary assembly 13 four inner lamination members 4 provided between the outer lamination members 1 allow for relative movement of the moveable assembly 21 between the stationary assembly 13 outer member 1 laminations as best shown in FIG. 19.

The stationary assembly 13 intermediate portion 14, handle portion 15, horizontal middle bar 16, and two leg portions 17 and 18 laminations are interconnected by a plurality of rivets 8, in a manner as is generally known, in order to hold the laminated construction of the stationary assembly 13 together. The stationary assembly 13 jaw portion 19 laminations are interconnected by removable fasteners 9, in a manner as is generally known, in order to hold the laminated construction of the stationary assembly 13 together and allow for ease of replacement. In addition, the moveable assembly 21 moveable jaw portion 22 and two teeth portions 24 and 25 laminations are interconnected by removable fasteners 9, in a manner as is generally known, in order to hold the laminated construction together and allow for ease of replacement.

All laminations are preferably die-stamped and/or water jet or laser cut from sheet steel or alternative materials and processes, such as forged or die cast metallic materials, or tool steel. Stationary assembly 13 filler member 2, handle member 5, and tooth member 4, in addition to moveable assembly 21 tooth member 7 may be provided by injection molded resinous plastic materials, or other conventional materials previously used or usable. Stationary assembly 13 tooth member 4 and moveable assembly 21 tooth member 7 may be manufactured from a variety of replaceable materials designed to grasp the concrete or cinder block and/or other object better.

Alternative construction techniques such as single-sided constructions typically found in scissors can be considered instead of the symmetrical laminations using a construction of inter-penetrating members. Member 3 and the entire assemblies 13 and 21 can alternatively be forged or die-cast metal, or injection molded resinous plastic with or without metallic inserts. The described materials and processes can be used in various combinations for achieving different self-adjusting and/or self-locking lifting device designs for different applications.

In accordance with an important aspect of the present invention, the stationary assembly 13 further includes a removable first pivot 1ST, member 10, means on the connection portion 20 permitting the moveable assembly 21 moveable jaw portion 22 to rotate toward the stationary horizontal middle bar portion 16 as a concrete or cinder block web is inserted between the two stationary legs portions 17 and 18 and to converge on a concrete or cinder block web and grasp the concrete or cinder block web in response to an upward movement of the stationary handle portion 15. The moveable assembly 21 also includes a removable second pivot 2ND, member 11, means on the moveable jaw portion 22 and operating lever 3 permitting the gravity biased operating lever 3 to move freely until an object is gripped between the stationary jaw portion 19 and moveable jaw portion 22 and the stationary handle portion 15 is lifted and/or raised to lift and/or raise the object. When the stationary jaw portion 19 and moveable jaw portion 22 grip the object, the operating lever 3 is prevented by the concrete or cinder block weight from releasing the concrete or cinder block until the concrete or cinder block places no gravitational and/or pinching force on the jaws and the operating lever 3 is lifted and/or raised to release or disengage the moveable jaw portion 22 from gripping the concrete or cinder block.

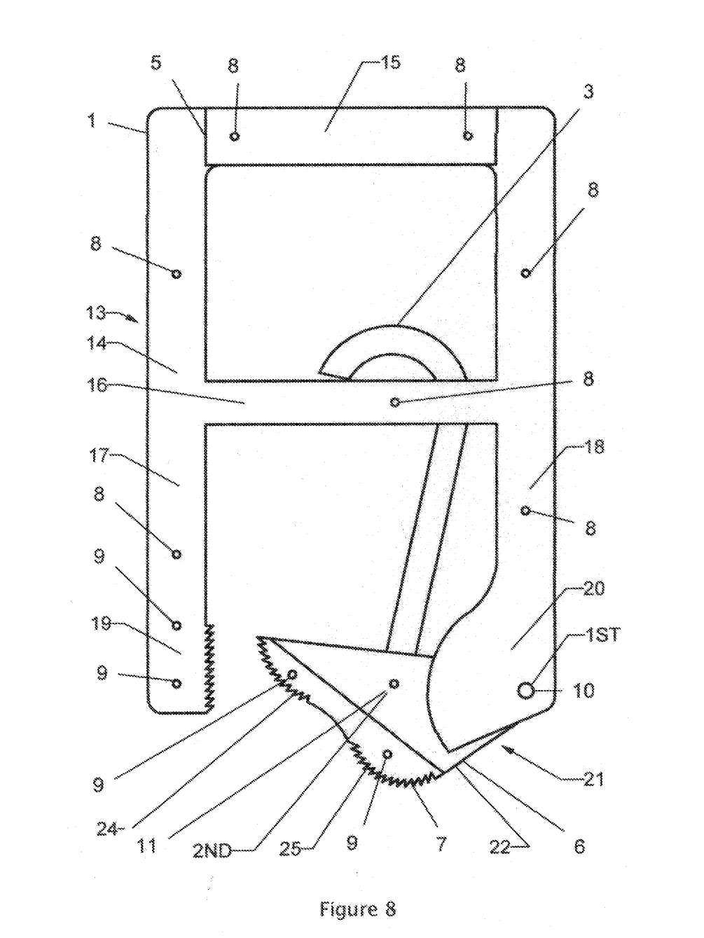

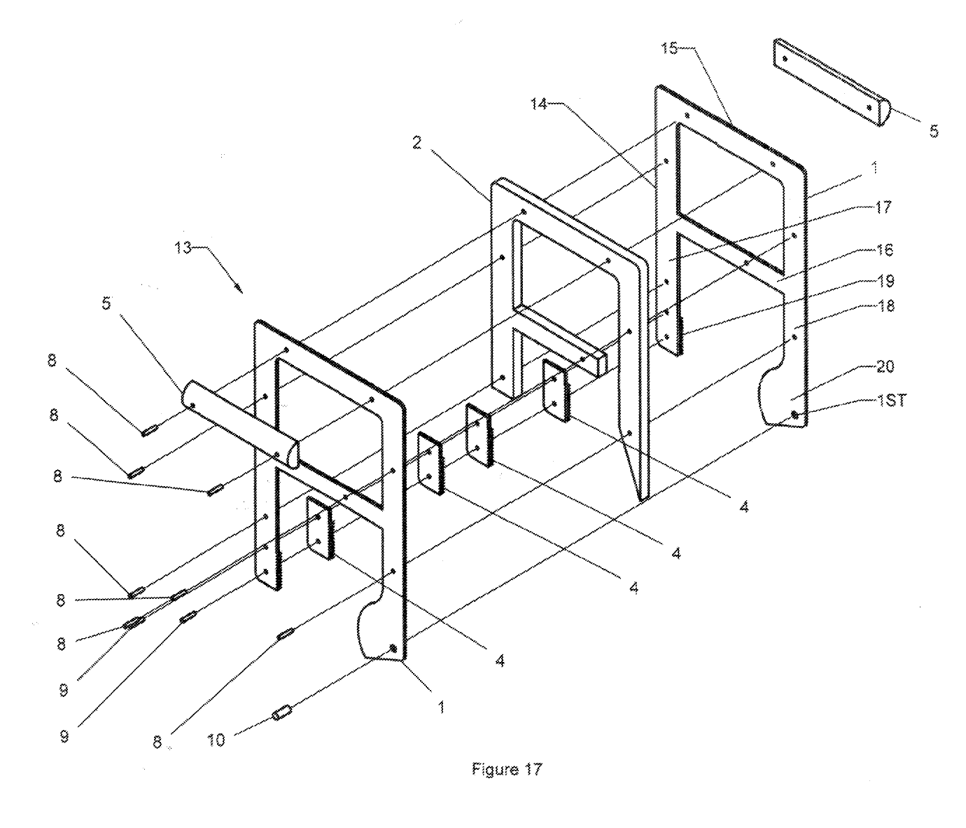

Referring to FIGS. 1 and 8-16, the operation of the self-adjusting and/or self-locking concrete or cinder block lifting device and the self-adjustment thereof to grasp a concrete or cinder block will be described. Specifically, FIGS. 1 and 8 show the self-adjusting and/or self-locking concrete or cinder block lifting device in a fully extended, default, or non-grasping position with no objects between the stationary jaw portion 19 and moveable jaw portion 22. The moveable jaw portion 21 is allowed limited rotation about the first pivot pin 1ST and is secured to the stationary assembly 13 by the first pivot pin 1ST. The operating lever 3 is allowed limited rotation about the second pivot pin 2ND and is secured to the moveable jaw portion 22 by the second pivot pin 2ND. In addition, the operating lever 3 is secured by and provided limited movement by an opening in the stationary horizontal middle bar portion 16. When the stationary assembly 13 is in an upright position, the stationary handle portion 15 is furthest up and the stationary jaw portion 19 is furthest down while the stationary leg portions 17 and 18 are vertical as shown in FIGS. 1 and 8, the curved end of the operating lever 3 will rest on the stationary horizontal middle bar portion 16 and allow the moveable jaw portion 22 to rotate to the maximum extent away from the stationary horizontal middle bar portion 16. The moveable jaw portion 22 will rest in a fully extended and/or most closed position where the distance between the stationary jaw portion 19 and moveable jaw portion 22 is the least. When the stationary assembly 13 is in an upside-down position, the stationary handle portion 15 is furthest down and the stationary jaw portion 19 is furthest up while the stationary leg portion 17 and 18 are vertical as if FIGS. 1 and 8 were rotated 180 degrees about a horizontal axis, the moveable jaw portion 22 will rotate to the maximum extent toward the stationary horizontal middle bar portion 16 where the distance between the stationary jaw portion 19 and moveable jaw portion 22 is the maximum and the distance between the curved end of the operating lever 3 and the stationary handle portion 15 will be the least. If the stationary assembly 13 is in any other position and/or orientation, the location of both the moveable jaw portion 22 and the operating lever 3 will be between the above limits.

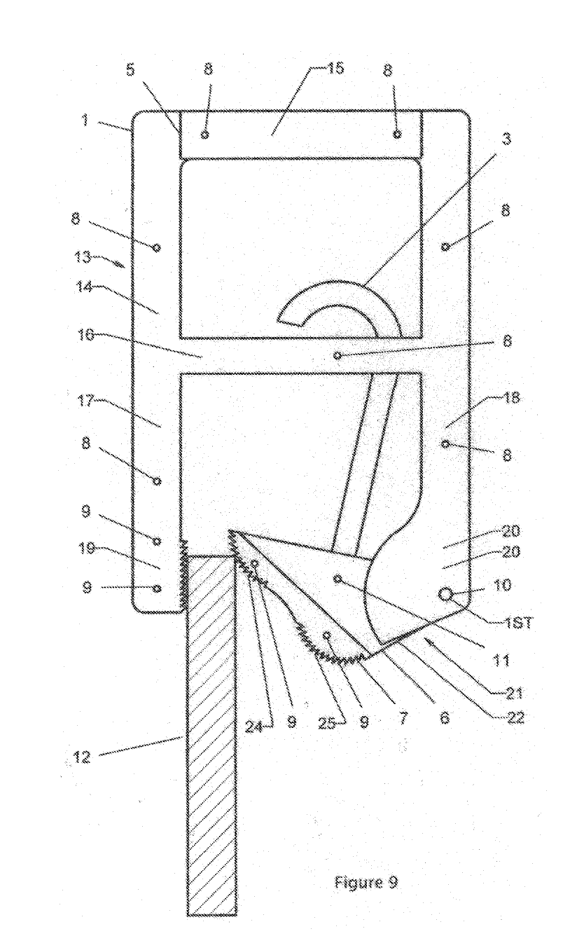

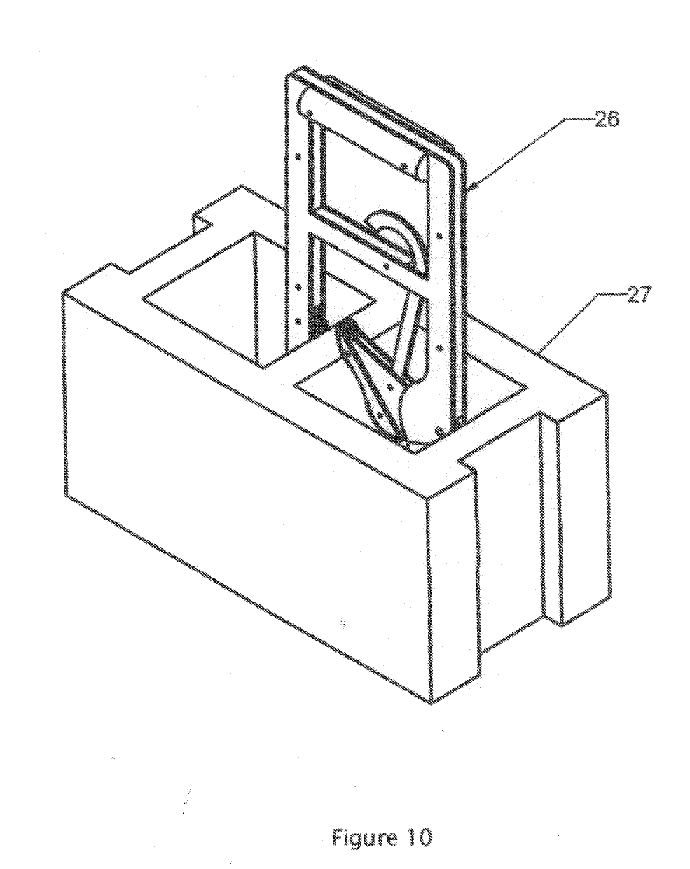

Referring to FIGS. 9 and 10, the first step in grasping and lifting a concrete or cinder block 27 with a thin web 12 using the self-adjusting and/or self-locking concrete or cinder block lifting device 26 is to place the device over the center-most web 12 of a concrete or cinder block 27. The self-adjusting and/or self-locking concrete or cinder block lifting device 26 opening between the stationary jaw portion 19 and the moveable jaw portion 21 should be placed directly over the center-most web 12 of a concrete or cinder block 27. The stationary jaw portion 19 teeth and moveable jaw portion 22 teeth 24 should be in contact with and on opposite sides of the concrete or cinder block web 12.

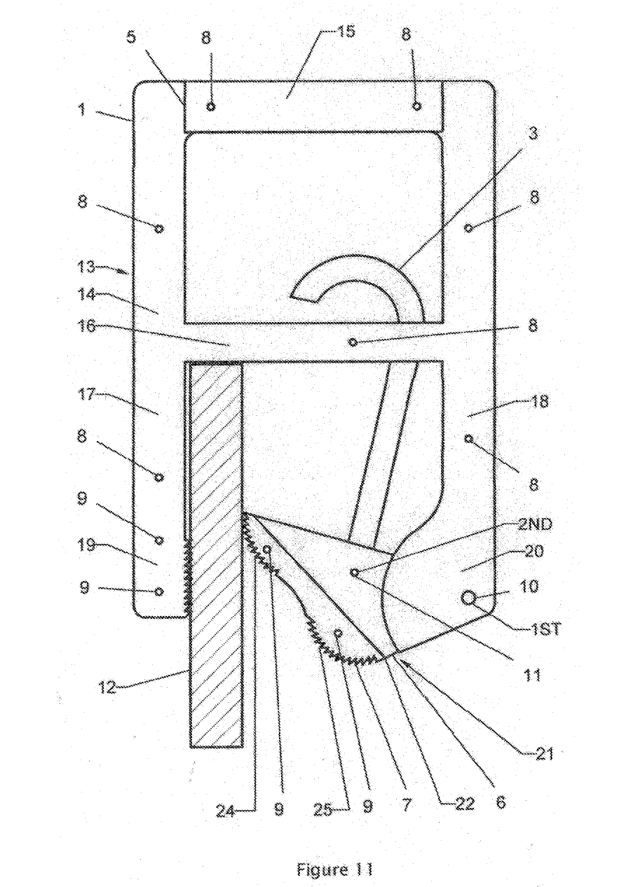

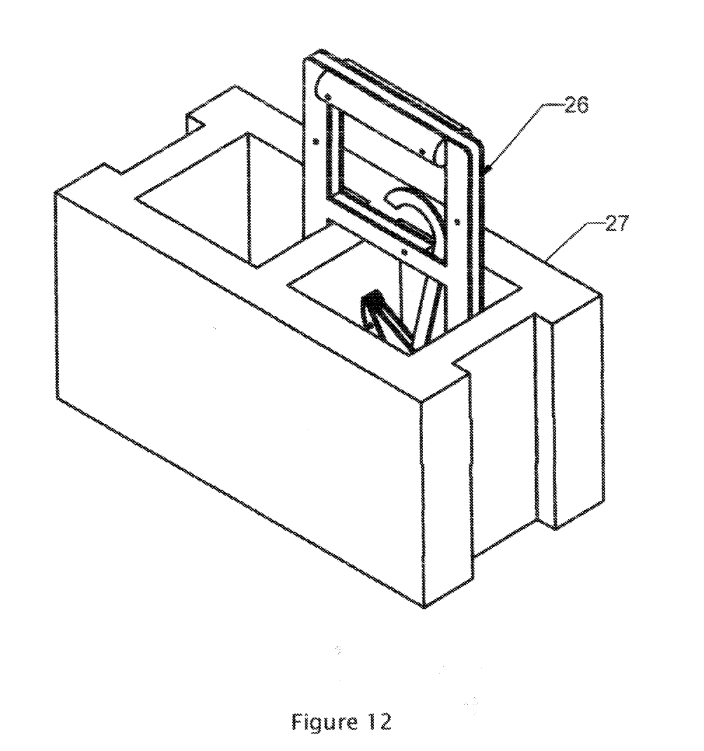

Referring to FIGS. 11 and 12, the second step is to push down on the stationary handle portion 15, allowing the self-adjusting and/or self-locking concrete or cinder block lifting device 26 to straddle and to slide down the concrete or cinder block web 12 until contact is made between the stationary horizontal middle bar portion 16 and the top of the concrete or cinder block web 12. The stationary leg portions 17 and 18 should straddle directly opposite sides of the concrete or cinder block center-most web 12. The moveable jaw portion 22 will be displaced by the concrete or cinder block web 12 since the opening between the stationary jaw portion 19 and moveable jaw portion 22 is too small for thin and/or thick concrete or cinder block webs 12. The moveable jaw portion 22 will rotate on the first pivot pin 1ST upward toward the stationary horizontal middle bar portion 16. Gravity and/or moveable assembly 21 weight will cause the moveable teeth portion 24 to maintain contact with one side of the concrete or cinder block web 12. The stationary jaw portion 19 teeth will be in-line with the moveable teeth portion 24 and be located on the opposite side of the concrete or cinder block web 12. As the moveable jaw portion 22 rotates upward, the operating lever 3 will be moved upward toward the stationary handle portion 15 as the operating lever 3 rotates about the second pivot pin 2ND and is guided by an opening in the stationary horizontal middle bar portion 16. This step will result in the self-adjusting and/or self-locking concrete or cinder block lifting device 26 being fully inserted over the concrete or cinder block web 12 with the stationary legs 17 and 18 being on either side of the concrete or cinder block web 12 and the top of the concrete or cinder block web 12 top touching the stationary horizontal middle bar portion 16 with both the stationary jaw portion 19 teeth and moveable teeth portion 24 touching directly opposite sides of the concrete or cinder block web 12.

Again referring to FIGS. 11 and 12, the third step is to pull up on the stationary handle portion 15, allowing the self-adjusting and/or self-locking concrete or cinder block lifting device 26 to grasp the concrete or cinder block web 12. Pulling up on the stationary handle portion 15 will cause the moveable jaw portion 22 to rotate downward or away from the stationary horizontal middle bar portion 16 on the first pivot pin 1ST as the stationary jaw portion 19 teeth and moveable teeth portion 24 grip the concrete or cinder block web 12 and concrete or cinder block weight pulls the moveable jaw portion 22 downward, due to gravity. The moveable jaw portion 22 downward rotation and design shape will result in the concrete or cinder block web 12 being pinched and/or gripped between the stationary jaw portion 19 teeth and moveable teeth portion 24, creating a self-adjusting and/or self-locking concrete or cinder block lifting device 26. As long as the stationary handle portion 15 is pulled upward and the concrete or cinder block 27 weight pulls the moveable jaw 22 downward, the concrete or cinder block web 12 will be gripped, and the concrete or cinder block 27 may be lifted and/or transported.

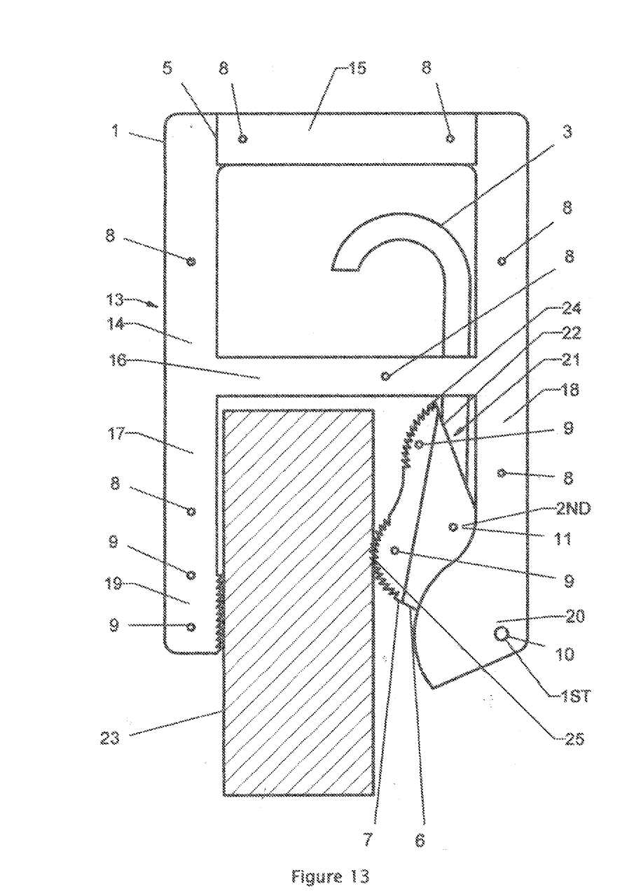

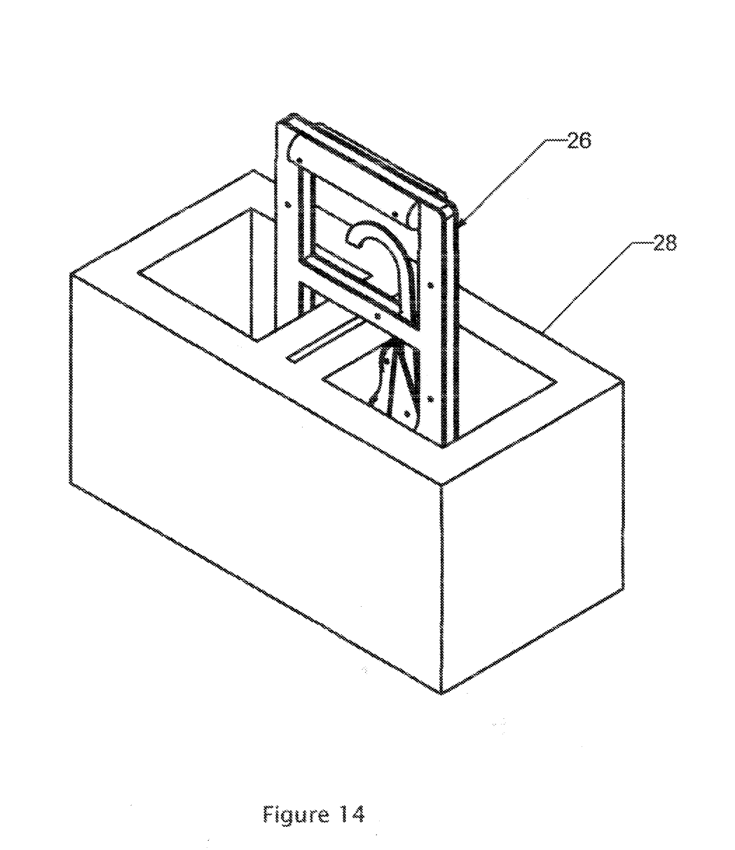

Referring to FIGS. 13 and 14, the first step in grasping and lifting a concrete or cinder block 28 with a thick web 23 using the self-adjusting and/or self-locking concrete or cinder block lifting device 26 is the same as for a thin web 12 concrete or cinder block 27. During the second step, complete insertion of the self-adjusting and/or self-locking concrete or cinder block lifting device 26 over the concrete or cinder block web 23 will increase the rotation of the moveable jaw portion 22. The moveable jaw portion 22 will rotate on the first pivot pin 1ST upward toward the stationary horizontal middle bar portion 16. Gravity and/or moveable assembly 21 weight will cause the moveable teeth portion 25 to maintain contact with one side of the concrete or cinder block web 23. The stationary jaw portion 19 teeth will be in-line with the moveable teeth portion 25 and be located on the opposite side of the concrete or cinder block web 23. Step three is the same as for a thin web 12 concrete or cinder block 27.

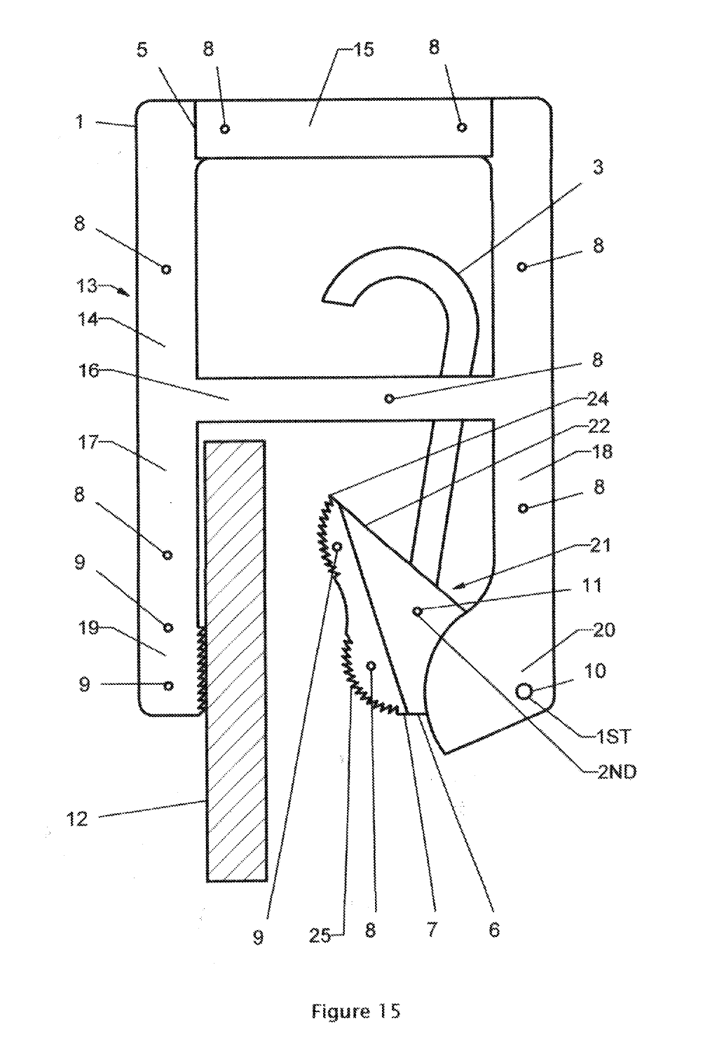

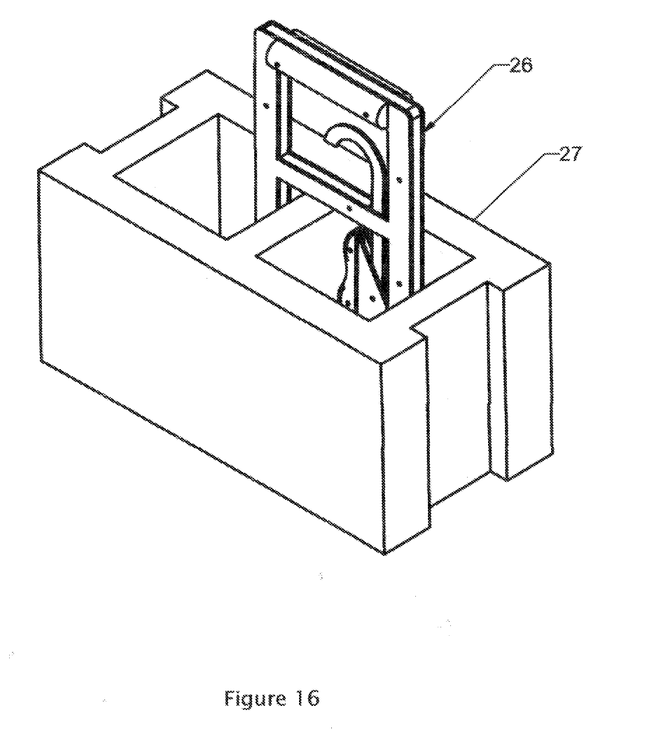

Referring to FIGS. 15 and 1 6, the fourth step is to disengage the self-adjusting and/or self-locking concrete or cinder block lifting device 26 from a thin 12 or thick 23 webbed concrete or cinder block 27 or 28. Once the concrete or cinder block 27 or 28 is placed on a surface and/or no weight is placed on the moveable jaw portion 22, the operating lever 3 may be pulled upward or toward the stationary horizontal middle bar portion 16. This action will rotate the moveable jaw portion 22 toward the stationary horizontal middle bar portion 16 by use of and rotation about the second 2ND and first 1ST pivot pins. Once the moveable teeth portion 24 or 25 are no longer in contact with the concrete or cinder block web 12 or 23, the self-adjusting and/or self-locking concrete or cinder block lifting device 26 may be pulled upward and away or disengaged from the concrete or cinder block 27 or 28.

Referring to FIGS. 1 and 8, when the concrete or cinder block is disengaged and the operating lever 3 is released, the self-adjusting and/or self-locking concrete or cinder block lifting device will return to the fully extended, default, or non-grasping position with no objects between the stationary jaw portion 19 and moveable jaw portion 22.

The radius defining the curvature and location of pivot pins 1ST and 2ND of the stationary assembly 13 and moveable assembly 21 are dependent on the relative thicknesses of concrete or cinder block webs 12 or 23 and the desired size of the mechanism and resulting self-adjusting and/or self-locking concrete or cinder block lifting device 26.

It will be appreciated that the present invention provides an improved hand held concrete or cinder block lifting device capable of self-adjusting and/or self-locking to grasp concrete or cinder block of different sizes and shapes. The unique design of the moveable assembly and arrangement of pivot means in cooperation with the stationary assembly described herein, as well as the ease of operation provides for an efficient and effective hand held concrete or cinder block lifting device that can be easily used by one hand of the user. It will be appreciated that the arrangement of the particular self-adjusting and/or self-locking concrete or cinder block lifting device in grasping the concrete or cinder block may be varied in an assortment of ways in order to achieve the present invention and that the particular manner in which the invention has been described herein is only for illustration purposes. The concrete or cinder block lifting device may be placed on varying shapes and types of concrete or cinder block and/or other objects in a variety of arrangements.

It will also be understood that descriptions of the invention herein relating to relative orientation of terms, such as, for example, “up” or “down”, “upward” or “downward”, “inner” or “outer”, “top” or “bottom” are applicable to the figures and illustrations set forth herein but may be otherwise according to the particular orientation of the self-adjusting and/or self-locking concrete or cinder block lifting device and how the device is being applied.

Whereas particular embodiments of the present invention have been described herein for purposes of illustration, it will be evident to those skilled in the art that numerous variations of the details may be made without departing from the invention as defined in the appended claims.

What is claimed is:

1. I claim a self-adjusting and/or self-locking concrete or cinder block lifting device for grasping a concrete or cinder block and/or other object comprising:
a stationary assembly including a handle portion and moveable assembly including an operating lever and each assembly including a jaw portion, and an intermediate portion therebetween;
a first pivot means on said intermediate portions permitting said jaw portions to converge on the concrete or cinder block and grasp the concrete or cinder block in response to said stationary assembly handle portion being raised upward;
a second pivot means on said moveable assembly intermediate portion permitting a disengagement of the concrete or cinder block when the concrete or cinder block provides no weight on said moveable assembly and in response to the upward movement of said operating lever;
said first pivot means including jaw members secured by fasteners to said jaw portion of said moveable assembly and a generally arcuate rack formed on said jaw portion of said moveable assembly, said generally arcuate rack having a plurality of first teeth and said jaw members having a plurality of first teeth formed on a first side thereof adjacent said generally arcuate rack, said stationary assembly including jaw members secured by fasteners to said jaw portion of said stationary assembly and a general rack formed on said jaw portion of said stationary assembly, said general rack having a plurality of second teeth and said jaw members having a plurality of second teeth formed on a first side thereof adjacent said general rack, said plurality of second teeth in engagement with said plurality of first teeth of said generally arcuate rack during the continued movement of said stationary assembly handle portion upward to apply increasing grasping force to the concrete or cinder block.

2. I claim the self-adjusting and/or self-locking concrete or cinder block lifting device of claim 1 wherein
said stationary and moveable assembly members are of laminated construction; and
including means for connecting said stationary and moveable assembly members together; and
all said jaw members and moveable assembly are replaceable.

3. I claim the self-adjusting and/or self-locking concrete or cinder block lifting device of claim 1 wherein
said intermediate portion of said stationary assembly includes relatively spaced first and second outer laminations; and
said intermediate portion of said moveable assembly member being received between said first and second outer laminations.

4. I claim the self-adjusting and/or self-locking concrete or cinder block lifting device of claim 1 wherein
said first pivot pin and fastener of first pivot means having opposing ends of a first diameter for receipt in said positioning slot of said first and second outer laminations of said stationary assembly; and
said first pivot pin and fastener having an enlarged center portion of a second diameter greater than said first diameter, said enlarged center portion received between said first and second outer laminations of said stationary assembly adjacent said positioning slot of said first and second outer laminations of said stationary assembly.

5. I claim the self-adjusting and/or self-locking concrete or cinder block lifting device of claim 1 wherein
said second pivot pin and fastener of second pivot means having opposing ends of a first diameter for receipt in said positioning slot of said moveable jaw portion laminations of said moveable assembly; and
said second pivot pin and fastener having an enlarged center portion of a second diameter greater than said first diameter, said enlarged center portion received between said moveable jaw portion laminations of said moveable assembly adjacent said positioning slot of said moveable jaw portion laminations of said moveable assembly.

6. I claim the self-adjusting and/or self-locking concrete or cinder block lifting device of claim 1 wherein
said moveable assembly generally triangular jaw portion arcuate rack includes a plurality of teeth; and
said first or second region provide grasping force on a concrete or cinder block during the continued upward movement of said stationary assembly handle; and
said jaw members are manufactured from a variety of material as a means for better grasping concrete or cinder block and/or other objects.
